(19) United States
(12) Patent Application Publication
(10) Pub. No.: US 2014/0024489 A1
(43) Pub. Date: Jan. 23, 2014

(54) PLANETARY GEAR SET FOR A POWER TOOL

(71) Applicants: Andreas Heber, Bissingen An Der Teck (DE); Oliver Drews, Waldenbuch (DE)

(72) Inventors: Andreas Heber, Bissingen An Der Teck (DE); Oliver Drews, Waldenbuch (DE)

(21) Appl. No.: 13/977,783

(22) PCT Filed: Dec. 2, 2011
(86) PCT No.: PCT/EP2011/071594

§ 371 Date: Sep. 23, 2013

(30) Foreign Application Priority Data
Jan. 3, 2011 (DE) 10 2011 002 406.9

(51) Int. Cl. F16H 3/62

(52) U.S. Cl. CPC F16H 3/62
USPC 475/299; 475/337; 475/293

(57) ABSTRACT

A planetary gear set for a power tool is described, in particular for an electrically operated hand-held power tool. The planetary gear set has multiple gear stages, the planetary wheels of a gear stage, to which a movable annulus gear is assigned, being at least supported on shafts via rolling elements, the rolling elements being held on an assigned planet carrier.

### FIELD OF THE INVENTION

The present invention relates to a planetary gear set for a power tool, in particular for an electrically operated hand-held power tool.

### BACKGROUND INFORMATION

A hand-held power tool is described in German Published Patent Application No. 10 2004 058 809, which is designed as a cordless screwdriver, whose tool holder for accommodating a tool is driven via an electric drive motor and a multi-stage planetary gear set connected downstream from the drive motor.

Planetary gear sets of this kind may normally be shifted between two different gear stages, a slow rotational speed having a high torque being generated in the first gear stage and a higher rotational speed having a lower torque being generated in the second gear stage. The shifting takes place manually with the aid of a slider which, in the axial direction, displaces a shifting ring gear between a locked position and an unlocked position.

The high motor speeds are reduced via the planetary gear set into the operating speed of the tool spindle. For efficiency reasons, the friction in the drive unit including the drive motor and the planetary gear set is as low as possible.

### SUMMARY

An object of the present invention is to design a planetary gear set using simple constructive measures, which is used in a power tool, in such a way that friction losses are minimized.

The planetary gear set according to the present invention is used in power tools, preferably in hand-held power tools, in particular in hand-held power tools having an electric drive motor. The planetary gear set has multiple gear stages, each including planetary wheels supported rotatably on planet carriers. The planetary wheels of at least one gear stage are supported via rolling elements on a shaft which is held on the assigned planet carrier. The use of the rolling elements ensures that the planetary wheels of the stage in question also rotate under load with reduced friction, so that the friction losses are minimized, the heat generated by friction is reduced, and the efficiency is increased.

At least the planetary wheels of one gear stage, to which a movable annulus gear is assigned, are each supported on one shaft via rolling elements. The adjustable annulus gear is advantageously a component of a torque clutch or a gearshift.

However, it is in principle also possible to support the planetary wheels of multiple gear stages or all gear stages via rolling elements. Within a gear stage, all planetary wheels are supported via rolling elements.

According to another advantageous embodiment, the rolling elements are designed as needle bushes, which in each case rest on the shaft, which is the carrier of the planetary wheel in question.

According to yet another advantageous embodiment, a total of three gear stages are provided, the planetary wheels of each gear stage being advantageously supported in the aforementioned manner via rolling elements.

The planetary gear set is advantageously designed to be shiftable for setting at least two different gear stages. The shifting between the two gears takes place by axial displacement of a shifting ring gear, which is displaceable between a locked position and an unlocked position. In the locked position, the shifting ring gear is coupled fixedly to the housing; in the unlocked position, it is coupled to a planet carrier of a gear stage, preferably the second gear stage. At least the planets on this planet carrier are supported on the shafts via the rolling elements, the shifting under load being improved or made easier by the design according to the present invention.

According to yet another advantageous embodiment, an annulus gear of the planetary gear set, preferably the annulus gear of the third stage, which is adjacent to the tool spindle, is a part of a torque clutch for setting a maximally transferable torque. The annulus gear of this stage is rotationally movable in relation to the housing. The planetary wheels of this gear stage are also advantageously supported via rolling elements.

The shifting ring gear, via which the different gear stages in the gear set are set, is advantageously coupled to a slider, which is situated on the outside of the housing and is adjustable by the operator. A spring element is situated advantageously between the slider and the shifting ring gear in order to carry out coupling operations not abruptly, but instead with a defined flexibility due to the resilient properties.

Overall, the design of the planetary gear set according to the present invention for a power tool has the advantage that it is possible to shift the gear set under load, heat generation and load are reduced, and moreover, the influence of manufacturing tolerances on gear set functions is reduced. At least the planetary wheels of a gear stage, preferably of the shiftable gear stage, whose annulus gear is movable either axially or rotationally for setting the various gear stages, are supported on rolling elements. These rolling elements are advantageously needle-shaped and placed on shafts, which are situated on the planet carrier of the gear stage in question. Additionally or alternatively to the gear stage, which takes over the gear shifting, the planets of a gear stage which is a component of a torque clutch may also be supported on rolling elements.

The heat generation is reduced both at no-load and under load. The displacement resistance during shifting operations for shifting between the gear stages is reduced; the variance of clutch release torques is also reduced.

### BRIEF DESCRIPTION OF THE DRAWINGS

FIG. 1 shows a section through a hand-held power tool in the longitudinal direction in the area of a shiftable planetary gear set having three gear stages, it being necessary to adjust a shifting ring gear axially for shifting between two gears.

FIG. 2 shows an exploded view of the components of the shiftable gear stage.

### DETAILED DESCRIPTION

Identical components are provided with the same reference numerals in the figures.

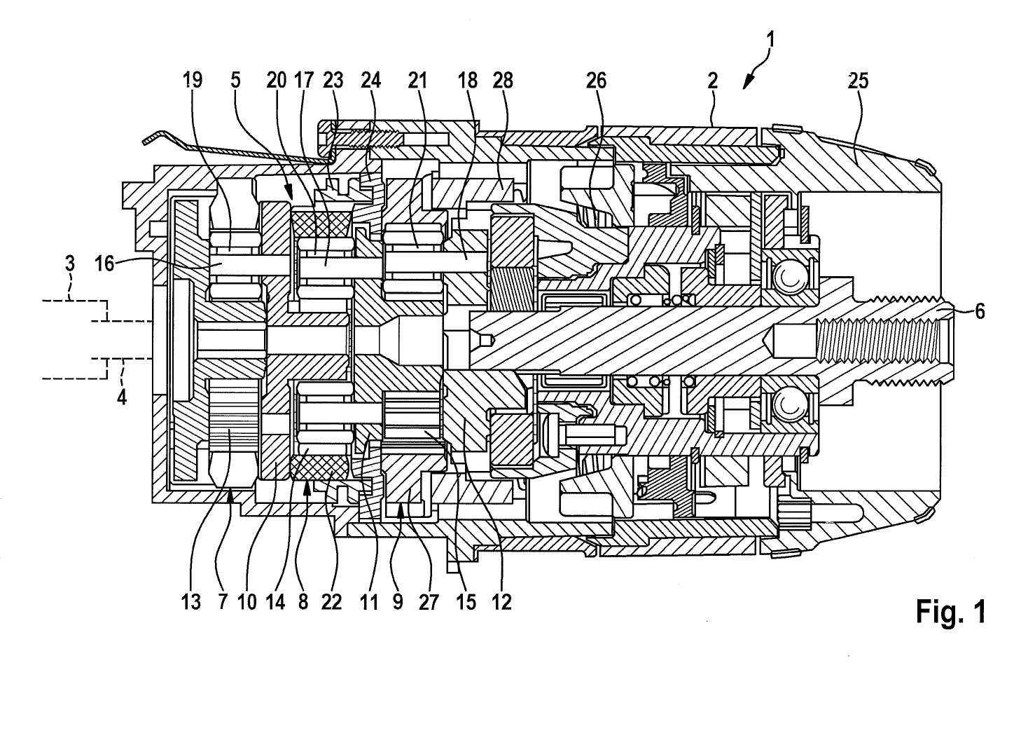

Hand-held power tool 1 shown in FIG. 1 is, for example, a cordless screwdriver or cordless drill. Hand-held power tool 1 has, in a housing 2, an electric drive motor 3 shown in outline having a motor shaft 4, which drives a planetary gear set 5 in housing 2. On the output side, planetary gear set 5 is coupled to a spindle 6 and drives the latter. Spindle 6 is provided with a tool holder for accommodating a tool.

Planetary gear set 5 is implemented in three stages and includes three gear stages 7, 8, 9, which include a planet carrier 10 of the first stage having planetary wheels 13, a planet carrier 11 of the second stage having planetary wheels 14 and a planet carrier 12 of the third stage having planetary wheels 15. All planetary wheels 13, 14, 15 of the first, second and third gear stage are rotatably supported on shafts 16, 17, 18 of respective planet carriers 10, 11 and 12. Planetary wheels 13, 14, 15 are each supported on respective shafts 16, 17, 18 via rolling elements 19, 20, 21, resulting in the friction being significantly reduced. Rolling elements 19, 20, 21 are formed, for example, as needle bushes.

Planetary gear set 5 may be shifted between a first gear having a slower rotational speed, but greater torque, and a second gear having a higher rotational speed, but less torque. The shifting state is changed with the aid of a shifting ring gear 23, which is assigned to second gear stage 8. Shifting ring gear 23 engages an annulus gear 22 of the second stage, and must be displaced axially between a locked position in which shifting ring gear 23 is locked to a housing-side locking ring 24, and an unlocked position, in which shifting ring gear 23 is connected to annulus gear 22 of the second stage and planet carrier 10 of the first stage, and rotates together with them. In the locked position in which shifting ring gear 23 is locked, the second gear stage is activated, this position corresponding to the first gear of the hand-held power tool having a slow rotational speed. In the unlocked position in which shifting ring gear 23 is connected to annulus gear 22 of the second stage and planet carrier 10 of the first stage, the second gear stage is shut down, this position corresponding to the second gear of the power tool having a high rotational speed.

In an alternative embodiment, annulus gear 22 of the second stage is simultaneously designed as a shifting ring gear which must be displaced between a housing-fixed locked position and an unlocked position.

The adjusting movement for adjusting shifting ring gear 23 is carried out using a slider situated on the outside of the housing, the slider being connected to shifting ring gear 23 via a spring element.

A torque clutch for setting a maximally transferable torque is implemented via third gear stage 9. To that end, various torques may be set via an adjusting ring 25 in the front area of the hand-held power tool. Via adjusting ring 25, the pre-load of compression springs 26 is variable, the torque clutch being disengaged sooner with lower spring pre-load, in that an annulus gear 27 of third gear stage 9 latches to a locking disc 28, which is subjected to the pre-load of compression springs 26.

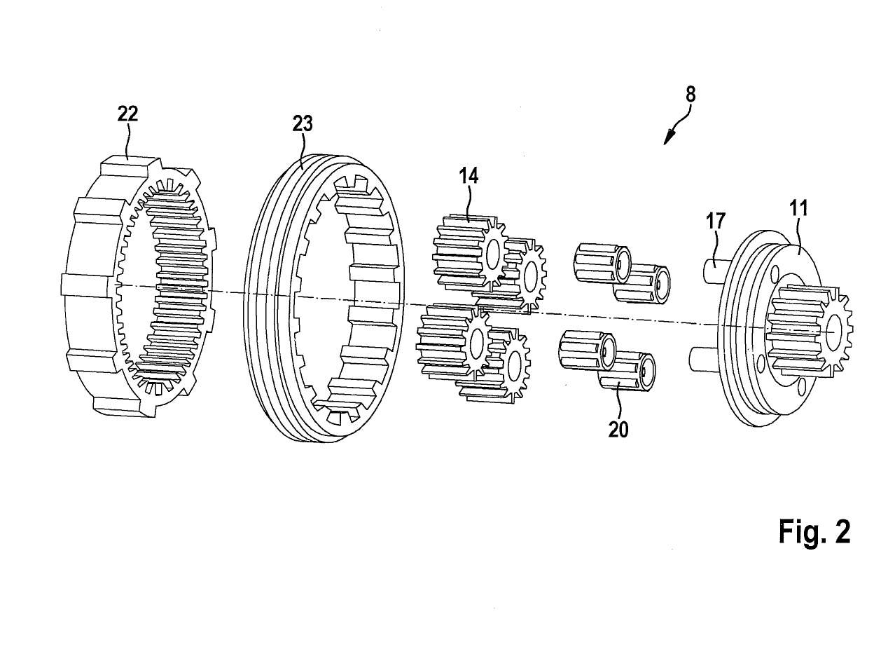

In FIG. 2, the various components of second gear stage 8 are shown in exploded view. The components include annulus gear 22 of the second stage, shifting ring gear 23 situated so as to be axially displaceable, and planetary wheels 14 on planet carrier 11 of the second stage. For a low-friction bearing, planetary wheels 14 are held on shafts 17 on planet carrier 11 via rolling elements 20 designed as needle bushes. Distributed across the circumference, multiple planetary wheels 14 are held on planet carrier 11.

1.-11. (canceled)

12. A planetary gear set for a power tool, comprising:
a plurality of shafts;
a plurality of rolling elements;
a plurality of planet carriers; and
multiple gear stages, wherein:
at least one gear stage includes an annulus gear that is movable in relation to a housing,
the at least one gear stage includes planetary wheels which are each supported on a respective one of the shafts via a respective one of the rolling elements, and
the shafts are held on assigned ones of the planet carriers.

13. The planetary gear set as recited in claim 12, wherein the planetary wheels of all the gear stages are supported on the shafts via the rolling elements, the shafts being held on the assigned planet carriers.

14. The planetary gear set as recited in claim 12, wherein the gear stages include a total of three gear stages.

15. The planetary gear set as recited in claim 12, wherein the rolling elements include needle bushes.

16. The planetary gear set as recited in claim 12, wherein the annulus gear is a component of a torque clutch for setting a maximally transferable torque.

17. The planetary gear set as recited in claim 16, wherein the annulus gear is rotationally movable in relation to the housing.

18. The planetary gear set as recited in claim 12, wherein the planetary gear set is shiftable for setting at least two different gears.

19. The planetary gear set as recited in claim 18, further comprising:
a shifting ring gear that is displaceable between a locked position and an unlocked position, the shifting ring gear being coupled fixedly to the housing in the locked position and being coupled to one of the planet carriers of an adjacent one of the stages in the unlocked position.

20. The planetary gear set as recited in claim 19, further comprising:
a slider; and
a spring element via which the shifting ring gear is coupled to the slider.

21. The planetary gear set as recited in claim 19, wherein the shifting ring gear is axially displaceable.

22. The planetary gear set as recited in claim 12, wherein the power tool is an electrically operated hand-held power tool.

23. A power tool, comprising:
a planetary gear set that includes:
a plurality of shafts;
a plurality of rolling elements;
a plurality of planet carriers; and
multiple gear stages, wherein:
at least one gear stage includes an annulus gear that is movable in relation to a housing,
the at least one gear stage includes planetary wheels which are each supported on a respective one of the shafts via a respective one of the rolling elements, and
the shafts are held on assigned ones of the planet carriers.

24. The power tool as recited in claim 23, wherein the power tool is an electrically operated hand-held power tool.
